(19) United States
(12) Patent Application Publication
(10) Pub. No.: US 2026/0142900 A1
(43) Pub. Date: May 21, 2026

(54) SYSTEMS AND METHODS FOR NETWORK DATA QUALITY MANAGEMENT

(71) Applicant: Level 3 Communications, LLC, Denver, CO (US)

(72) Inventors: Todd VINCENT, Owasso, OK (US); Randy BEESLEY, Sand Springs, OK (US); Ethan CHAMBERS, Westminster, CO (US); Bobby PERRITT, Oologah, OK (US)

(73) Assignee: Level 3 Communications, LLC, Denver, CO (US)

(21) Appl. No.: 19/340,593

(22) Filed: Sep. 25, 2025

Related U.S. Application Data
(60) Provisional application No. 63/722,282, filed on Nov. 19, 2024.

(51) Int. Cl. H04L 43/045; H04L 41/069; H04L 41/16

(52) U.S. Cl. CPC H04L 43/045; H04L 41/069; H04L 41/16

(57) ABSTRACT

Disclosed are systems and methods that provide a decision-intelligence (DI)-based, computerized framework for automatically and/or dynamically managing connectivity and/or operation of assets on/over an electronic network. The disclosed framework functions in relation to providing network management, inclusive of inventor and network reconciliation, via a network data quality management tool (NDQ). The NDQ framework is configured for advanced network data discovery, provisioning analysis, discrepancy resolution, monitoring processes, and the like. The disclosed NDQ framework serves as a comprehensive, automated solution for ensuring accurate network data and seamless network management by integrating advanced analytics, multi-platform compatibility, and automation capabilities. The framework operates to provide a unified, high-quality network data environment by aligning asset provisioning data with network provisioning data, identifying and resolving discrepancies, and enabling ongoing monitoring to maintain network integrity.

### CROSS-REFERENCE TO RELATED APPLICATIONS

This application claims the benefit of priority from U.S. Provisional Application No. 63/722,282, filed Nov. 19, 2024, which is incorporated by reference in its entirety herein.

### FIELD OF THE DISCLOSURE

The present disclosure relates to network management, and more particularly, to a decision intelligence (DI)-based computerized framework for automatically and/or dynamically managing connectivity and/or operation of assets on/over an electronic network.

### SUMMARY OF THE DISCLOSURE

Telecommunications teams managing site exits, network planning, and service disconnections face significant operational challenges in maintaining accurate inventory and network reconciliation. These challenges primarily stem from data synchronization issues across multiple platforms and systems.

Data discrepancies commonly arise from two main sources. First, human error during the manual merging of data from various platforms can introduce inaccuracies. Second, when automated cross-platform updates fail to complete successfully, the resulting fallout may go undetected, further compromising data integrity.

The process of identifying and resolving these discrepancies presents additional complications. The manual collection of system information is not only labor-intensive but also prone to errors. Team members must dedicate substantial time to comparing data sets across different systems, often without clear resolution procedures. The manual verification process itself can introduce new errors, creating a cycle of data quality issues.

Such challenges compound to create several operational impacts, which include, extended resolution timeframes, reduced data accuracy, increased operational costs, resource inefficiency, potential service delivery delays, and the like. The combination of manual processes, complex data relationships, and multi-platform dependencies creates a challenging environment for telecommunications teams to maintain accurate network and inventory records. These issues highlight the need for more efficient, automated solutions to manage data reconciliation and validation processes.

To that end, according to some embodiments, the disclosed systems and methods provide a novel computerized framework for network management, inclusive of inventor and network reconciliation, via a network data quality management tool (NDQ). As discussed herein, the disclosed NDQ framework provides a comprehensive solution for automated network element discovery and data reconciliation, integrating multiple network management functions into a unified platform that significantly reduces the operational complexity traditionally associated with network data management. In some embodiments, the NDQ framework can perform rapid network element identification across diverse network infrastructures, completing discovery cycles in as little as 15 minutes, for example. For example, the instant framework supports more than 50 different device types and maintains compatibility across multiple platform architectures, including DWDM (Dense Wavelength Division Multiplexing), SONET (Synchronous Optical Network), and IP/Ethernet networks.

According to some embodiments, the framework maintains seamless compatibility with various network management platforms through standardized application program interfaces (APIs) for cross-platform communication, thereby enabling real-time data synchronization capabilities. In some embodiments, a unified data model ensures consistent interpretation across all platforms, while the automated command generation system facilitates efficient network element interrogation. Such sophisticated integration framework eliminates the traditional barriers between different network management systems, creating a cohesive operational environment.

According to some embodiments, the framework's data reconciliation operations represent a significant advancement in network management automation. That is, in some embodiments, the framework's automated data collection mechanism generates and executes commands for network element data retrieval, thereby operating multiple parallel collection processes while maintaining comprehensive audit logs of all activities. Moreover, the framework operates advanced error handling and retry mechanisms to ensure robust data collection, even in challenging network conditions. In some embodiments, the collected data can undergo sophisticated analysis through advanced analytics that compare it against existing inventory records, thereby identifying discrepancies across multiple systems while applying validation rules specific to each network type. Such process generates detailed quality metrics that provide unprecedented visibility into network data integrity.

In some embodiments, NDQ's discrepancy management operations can employ sophisticated categorization mechanisms that evaluate identified issues based on multiple factors including severity level, service delivery impact, resolution complexity and required authorization levels. Each identified discrepancy can be accompanied by a comprehensive guided resolution framework that includes detailed conflict descriptions, root cause analysis and multiple resolution options with impact assessments. As discussed herein, step-by-step resolution procedures can be provided, which can be enhanced by historical resolution data for similar cases, thereby enabling operators to make informed decisions quickly and confidently.

According to some embodiments, the disclosed user interface and workflow management capabilities of NDQ set new standards for operational efficiency. The consolidated dashboard provides single-pane-of-glass visibility with real-time status updates and integrated access to billing information, order management, inventory systems and network element graphical user interfaces (GUIs). Such unified interface can eliminate the need for operators to navigate multiple systems, significantly reducing the time and effort required for data analysis and problem resolution. The framework's decision support capabilities present comprehensive data alongside historical resolution patterns, impact analyses, risk assessments, and compliance checks, enabling operators to make optimal decisions with confidence.

As discussed herein, in some embodiments, the disclosed framework's automated capabilities represent a cornerstone of NDQ's efficiency improvements. The framework includes sophisticated pre-configured automation scripts for common issues, while supporting customizable workflow automation that integrates seamlessly with existing network management systems. Provided rollback capabilities can ensure system integrity in the event of failed automations. Every automated resolution generates detailed log files, email notifications to stakeholders, and comprehensive audit trails for compliance purposes, while also capturing performance metrics for continuous system optimization.

According to some embodiments, NDQ delivers substantial operational improvements across multiple dimensions. Efficiency gains are realized through the dramatic reduction in manual data gathering requirements and the elimination of multiple system access needs. Streamlined workflow processes and accelerated resolution timeframes contribute to significant time savings. Accuracy improvements are achieved through the reduction of human error in data collection, consistent application of resolution procedures, and validated data across multiple systems, resulting in superior data integrity throughout the network management ecosystem.

In some embodiments, the framework's integration and collaboration features extend its value proposition beyond basic network management. NDQ can seamlessly integrate with existing inventory management systems, billing platforms, order management systems, network monitoring tools, and trouble ticketing systems. Collaboration tools facilitate shared resolution workflows, team-based discrepancy management, and knowledge base integration, promoting best practices across the organization.

According to some embodiments, implementation flexibility can be ensured through multiple deployment options, including on-premises installation, cloud-based deployment, hybrid configurations, and high-availability options. Such integration process can follow a structured approach, beginning with system assessment and proceeding through configuration, testing, and production deployment phases. Such operational approach ensures successful implementation while minimizing operational disruption.

Accordingly, as discussed herein, according to some embodiments, the disclosed NDQ framework provides a transformative solution in network data management and reconciliation. In some embodiments, by automating discovery processes, providing guided resolution procedures, and implementing automated corrections, the disclosed framework can deliver substantial improvements in operational efficiency, data accuracy and cost optimization. The framework's ability to consolidate multiple system interfaces into a single platform, combined with its intelligent discrepancy management and resolution automation, provides organizations with a powerful solution for maintaining network data quality. Indeed, the resulting benefits include, but are not limited to, improved data integrity, streamlined workflows, significant cost savings through reduced manual intervention and accelerated resolution processes, and the like. As organizations continue to face increasing complexity in network management, the disclosed NDQ framework can provide a robust and efficient computerized solution for maintaining high-quality network data and streamlined operations, thereby providing an essential tool in modern network management infrastructure.

According to some embodiments, a method is disclosed for a DI-based computerized framework for automatically and/or dynamically managing connectivity and/or operation of assets on/over an electronic network. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and/or dynamically managing connectivity and/or operation of assets on/over an electronic network.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub- networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

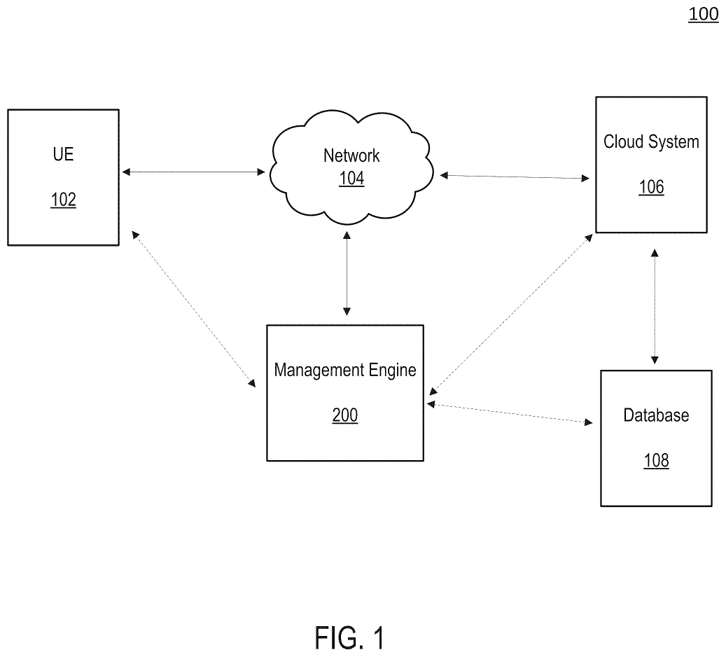

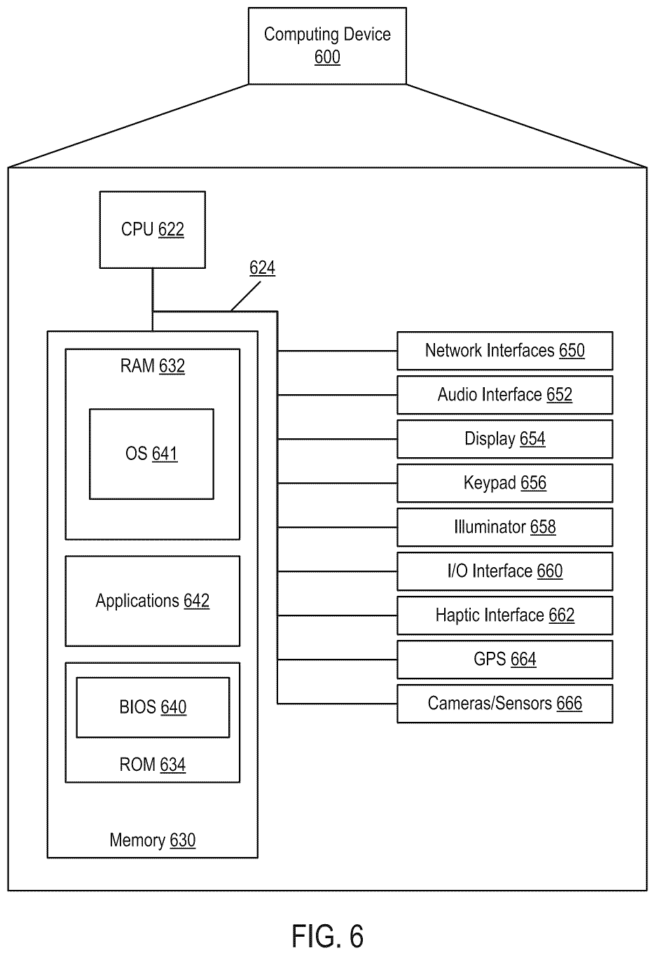

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and management engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network platform (e.g., Lumen® Technologies, for example), which has associated network resources hosted on the internet or private network (e.g., network 104), which enables (via engine 200) the functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

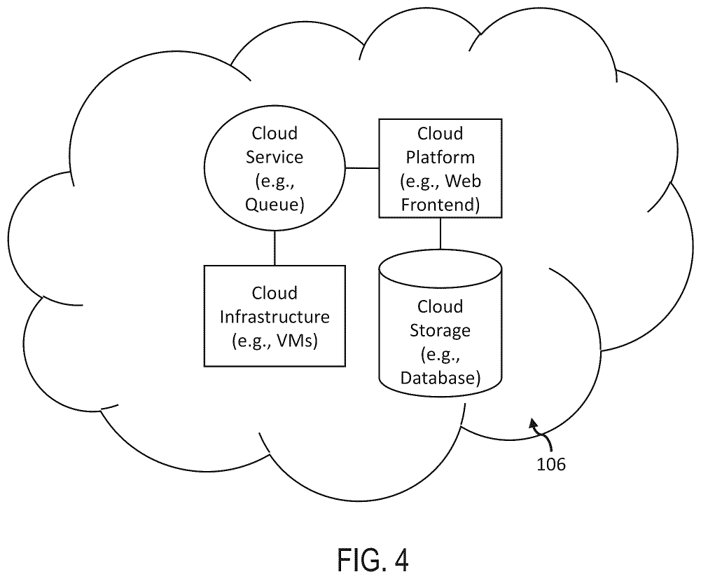

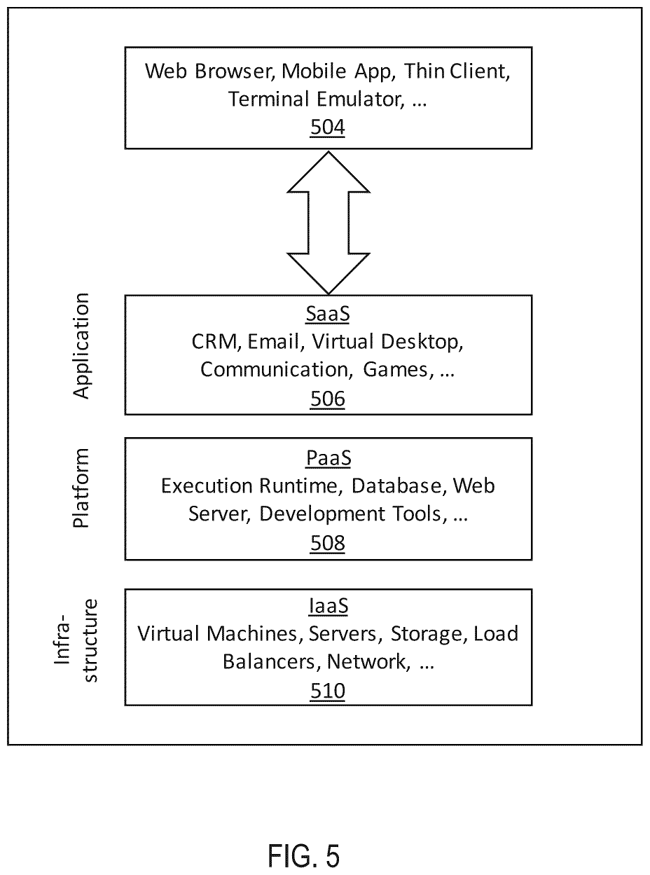

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: network as a service (NaaS) 510, platform as a service (PaaS) 508, and/or software as a service (SaaS) 506 using a web browser, mobile app, thin client, terminal emulator or other endpoint 504. In some embodiments, as understood by those of skill in the art, an infrastructure as a service (IaaS) can be implemented - for example, as part of and/or in addition to SaaS 506, PaaS 508 and/or NaaS 510. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 may be a special purpose machine or processor, and can be hosted by a device on network 104, within cloud system 106, and/or on UE 102. In some embodiments, engine 200 may be hosted by a server and/or set of servers associated with cloud system 106.

According to some embodiments, as discussed in more detail below, management engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below.

According to some embodiments, as discussed above, management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

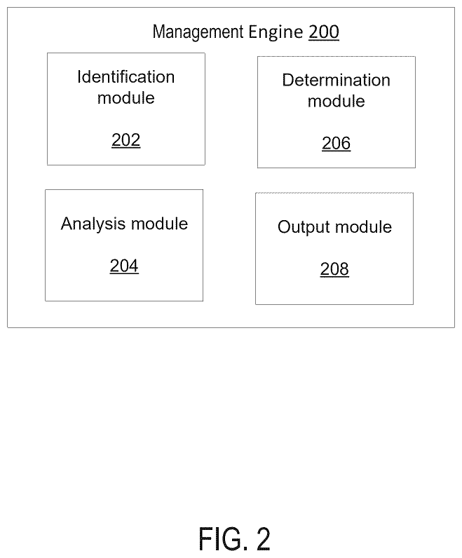

As illustrated in FIG. 2, according to some embodiments, management engine 200 includes identification module 202, analysis module 204, determination module 206 and output module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below. Management engine 200 or other device(s) running Process 300 may be operated entirely at the user device level, or with cloud support as a distributed system, or at a service provider's infrastructure, as non-limiting implementation examples. It will be understood that the disclosure herein provides for a configuration that is platform agnostic and may be operated on multiple alternative platforms as a matter of design choice using the teachings described.

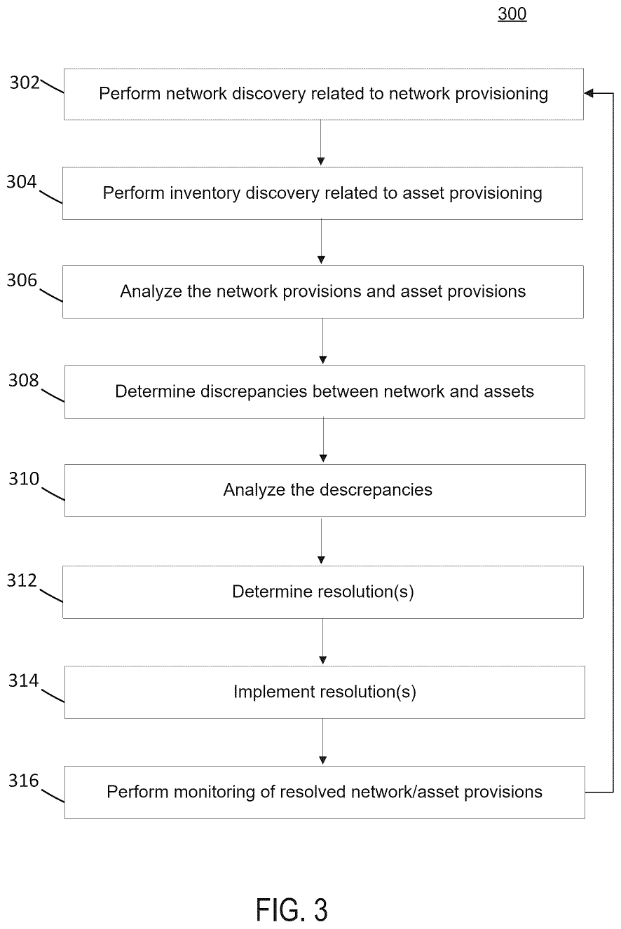

Turning to FIG. 3, depicted is Process 300 which details non-limiting example embodiments for network data quality management that is configured for advanced network data discovery, provisioning analysis, discrepancy resolution, monitoring processes, and the like. The disclosed NDQ framework serves as a comprehensive, automated solution for ensuring accurate network data and seamless network management by integrating advanced analytics, multi-platform compatibility, and automation capabilities. Operation of the disclosed framework, as discussed below in relation to the steps of Process 300 contribute to a unified, high-quality network data environment by aligning asset provisioning data with network provisioning data, identifying and resolving discrepancies, and enabling ongoing monitoring to maintain network integrity.

According to some embodiments, Steps 302, 304 and 314 of Process 300 can be performed by identification module 202 of management engine 200; Steps 306 and 310 can be performed by analysis module 204; Steps 308 and 312 can be performed by determination module 206; and Step 314 can be performed by output module 206.

According to some embodiments, Process 300 begins with Step 302 where engine 200 can perform network discovery related to network provisioning. Step 302 involves engine 200 performing rapid and thorough network element identification across a variety of network infrastructures. Such discovery process is technically complex, requiring compatibility with multiple network architectures, including Dense Wavelength Division Multiplexing (DWDM), Synchronous Optical Network (SONET), and IP/Ethernet. With its capability to support over 50 different device types, engine 200 can provide an extensive scan of the network landscape, identifying both active and passive network elements in real-time.

According to some embodiments, engine 200 can operate with high efficiency, completing discovery cycles in as little as 15 minutes by employing parallel processing techniques. Such techniques allow engine 200 to issue simultaneous discovery commands across network segments, making it highly efficient for both small-scale and large-scale networks. Each network element discovery session can be supported by automated query generation and standardized APIs, ensuring data is uniformly collected from various devices regardless of manufacturer or architecture. Such standardization not only enables comprehensive network visibility but also ensures the data collected is formatted consistently for downstream processes.

In some embodiments, engine 200's network discovery capabilities can extend beyond basic element identification - that is, in some embodiments, engine 200 can also access network configuration details, routing information, bandwidth usage, device status, and the like, or some combination thereof. Such level of granular data collection facilitates accurate network provisioning by providing operators with a detailed view of the network's current operational state, thereby enabling them to make informed decisions about provisioning and resource allocation.

In Step 304, engine 200 can perform inventory discovery related to asset provisioning. Accordingly, in some embodiments, following network discovery, engine 200 can proceed to conduct inventory discovery for asset provisioning by connecting to multiple inventory management systems to retrieve up-to-date data on existing network assets. Engine 200's multi-platform compatibility plays a crucial role here, as it allows seamless integration with diverse inventory systems, whether they are on-premises, cloud-based, and/or hybrid. By standardizing the data exchange process through APIs, engine 200 ensures that inventory data can be consistently updated across platforms, thereby reflecting the most recent configuration changes, installations, or decommissions.

According to some embodiments, engine 200 performs a deep-dive analysis during the inventory discovery process, extracting data on asset specifications, operational status, service history and location. In some embodiments, engine 200 can employ advanced query algorithms to filter and retrieve specific asset data rapidly, which is essential for large-scale networks with thousands of elements. The ability to manage and cross-reference data from different sources, including billing platforms, order management systems, and inventory management tools, enables engine 200 to build an integrated view of network resources.

In some embodiments, for accurate provisioning, engine 200's inventory discovery process can handle complex data validation rules specific to each system and network type. For example, SONET-based networks may require unique data fields and validation checks compared to Ethernet-based networks. Engine 200's configurable data models allow it to adapt to these unique requirements, thereby ensuring that inventory data is not only complete but also contextually accurate.

In Step 306, engine 200 can analyze the network provisions (network data) and asset provisions (asset or provisions data). According to some embodiments, engine 200 can utilize an NDQ unified data model that serves as the foundation for this analysis by standardizing data points across various platforms, allowing engine 200 to cross-reference and align network provisioning data with inventory asset data accurately. By ensuring a consistent interpretation across all platforms, this model eliminates the data silos that often exist within traditional network management systems.

According to some embodiments, engine 200's analysis capabilities can extend to a wide array of technical parameters, including network configuration states, provisioning status, equipment utilization, and system dependencies. Leveraging advanced data correlation algorithms, engine 200 can detect patterns and potential misalignments between network elements and their associated inventory records. For example, engine 200 can identify discrepancies in bandwidth provisioning by comparing the configured capacity on network elements against the capacity listed in the inventory. Such discrepancies often indicate misconfigurations or outdated records, which, if left unresolved, can impact network performance and resource allocation.

According to some embodiments, the analysis in Step 306 can involve engine 200 implementing or executing any type of known or to be known computational analysis technique, algorithm, mechanism or technology to perform the analysis of the network data and asset/provisions data.

In some embodiments, engine 200 may execute and/or include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage a large language model (LLM), whether known or to be known. A LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the sensor data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In some embodiments, engine 200's data correlation process can involve validating data accuracy by applying predefined rules specific to each type of network and device. By using both automated rule-checking and advanced pattern recognition techniques, engine 200 can ensure that provisioning data aligns with established network policies and best practices. Such analysis phase sets the stage for precise and targeted discrepancy identification, enhancing the overall accuracy of the data management process, as discussed infra.

In Step 308, engine 200 can determine discrepancies between the network provisioning and the asset provisioning. Step 308 can be crucial for maintaining data quality, as discrepancies can lead to inefficient resource allocation, reduced network performance and increased operational costs. Engine 200's discrepancy detection operations can employ sophisticated analytics to identify gaps, inconsistencies, and anomalies across data points by comparing real-time network data with historical inventory records.

According to some embodiments, such discrepancy detection processing can involve determined classifications related to each issue based on severity, service impact and/or resolution complexity. In some embodiments, engine 200 can not only identify discrepancies, but also assesses their potential impact on network operations. For example, a minor discrepancy in asset location data can be categorized as low-severity, whereas a significant misalignment in bandwidth allocation can be classified as high-severity due to its potential impact on service delivery.

In some embodiments, engine 200's categorization operations can function to perform the prioritization of discrepancies by automatically assigning urgency levels and recommending appropriate actions. For example, discrepancies affecting critical service paths can be escalated for immediate attention, while those with minimal impact are deferred. Such prioritization can be further informed by AI/ML techniques (as discussed above) that analyze historical resolution patterns, enabling engine 200 to predict the likelihood of recurrence and long-term impact of each discrepancy.

In Step 310, engine 200 can perform operations to analyze the discrepancies (from Step 308). That is, in some embodiments, once discrepancies are identified, engine 200 performs an in-depth analysis of each discrepancy. Such analysis involves identifying the root causes, evaluating potential impacts, and/or recommending appropriate corrective actions. In some embodiments, engine 200 can assess each discrepancy's underlying factors, such as network configuration errors, outdated inventory records, and/or equipment malfunctions.

According to some embodiments, such analysis can be performed in a similar manner as the AI/ML and/or LLM analysis discussed above at least in relation to Step 306, discussed supra.

In some embodiments, Step 310 can involve engine 200 comparing the current discrepancies with (retrieved) historical resolution data, providing insights into similar issues encountered in the past. Such historical perspective enables engine 200 to suggest tried-and-tested solutions, reducing resolution time and minimizing the risk of repeated discrepancies. Furthermore, engine 200's discrepancy analysis can incorporate advanced diagnostic tools that allow simulations of potential solutions and their outcomes, thereby ensuring that the chosen resolution will address the root cause effectively without introducing new issues.

According to some embodiments, engine 200 can generate a comprehensive report for each discrepancy, which can detail the conflict, potential impacts, root cause, recommended resolution options, and the like, or some combination thereof. Such report, embodied as a displayable, electronic document or data structure (or file, object or item) can include an impact assessment, risk evaluation and/or compliance check for each proposed solution, providing a clear understanding of the implications associated with each resolution path.

In Step 312, engine 200 can determine resolutions for the identified discrepancies (from Step 308). According to some embodiments, engine 200 can function as a decision support system that offers multiple resolution options for each discrepancy, each accompanied by detailed impact assessments, compliance evaluations and/or risk analyses. Engine 200 can function, via the AI/ML and/or LLMs, discussed supra, to take into account the operational priorities and compliance requirements specific to each discrepancy, thereby ensuring that resolutions are both effective and aligned with network policies.

According to some embodiments, such determined resolution options can be tailored to each network and asset type, taking into consideration factors such as, but not limited to, network redundancy, resource availability, time sensitivity, and the like. In some embodiments, for example, for high-severity discrepancies, engine 200 can suggest or execute immediate remediation through automated commands, while for less critical issues, it may recommend deferred or manual resolution to optimize resource allocation.

Moreover, engine 200's AI/ML capabilities can enable engine 200 to continuously improve resolution recommendations based on historical data (and/or the determined resolutions and their implementation, as discussed below at least in relation to Steps 314 and 316). Such learning capability allows engine 200 to refine its decision-making process over time, offering increasingly precise and effective resolutions for recurring issues.

According to some embodiments, respective to the operations and determinations in at least Steps 308-312, APPENDIX A, as included in U.S. Provisional Application 63/722,282, incorporated herein, depicts non-limiting example embodiments of such discrepancies, resolutions and information associated therewith for performing such identification, determinations and/or implementations (as discussed below).

In some embodiments, Step 312 can involve a compilation and display of a dashboard, as discussed below, which can provide a ranked listing of resolutions (e.g., ranked based on how effective they are related to a complexity of the discrepancy), which can be selected (e.g., by an operator, engine 200, or other user/application), thereby triggering its implementation, as discussed below.

In Step 314, engine 200 can perform operations to implement (or execute) the determined resolution(s). According to some embodiments, engine 200 can execute automation scripts modified and/or configured to perform the determined resolution to the determined discrepancies and/or discrepancy types. Such resolutions, as discussed herein, as implemented/executed, can be performed as customizable workflows for complex issues. Thus, by automating the resolution process, engine 200 reduces the risk of human error and speeds up the correction of network and asset provisioning discrepancies.

According to some embodiments, engine 200 can employ rollback capabilities, which ensure that, in the event of a failed resolution, reversion to a pre-resolution state without compromising network stability can be performed. During each resolution, engine 200 can generate detailed log files and provides email notifications to stakeholders, offering full visibility into the resolution process. Comprehensive audit trails can also be maintained to facilitate compliance with regulatory requirements and internal policies, which can be stored in database 108, as discussed above.

According to some embodiments, each resolution can be evaluated for performance metrics, allowing engine 200 to identify opportunities for process optimization and improve future resolutions. Such continual feedback loop enhances engine 200's overall effectiveness, contributing to a more resilient and adaptable network data management system.

In Step 316, engine 200 can perform monitoring of the resolved network and/or asset provisions. In some embodiments, such monitoring can be effectuated by recursively performing the steps of Process 300, as depicted in FIG. 3, which can ensure that rollback operations and/or reperformance of newly determined resolutions can be decided upon based on network, asset and/or deficiency analysis, as discussed supra.

In some embodiments, engine 200 can provide an NDQ consolidated dashboard that provides an interactive display with a view of all network and asset data, including real-time updates on the status of resolved discrepancies. Such visibility, for example, enables operators to track the effectiveness of each resolution and quickly identify any new issues that may arise.

In some embodiments, engine 200's monitoring capabilities can be enhanced by advanced analytics, which continuously assess network performance metrics, data integrity and compliance with provisioning standards. Such monitoring process can be proactive, alerting operators to potential issues before they escalate into larger problems. In addition, engine 200 can maintain comprehensive audit logs and performance data for each resolution, enabling operators to assess long-term trends and optimize network provisioning practices.

In some embodiments, in cases where resolved issues re-emerge, engine 200's monitoring framework allows it to immediately initiate discrepancy analysis and resolution processes, ensuring that network data quality remains consistently high. Such proactive approach to monitoring supports continuous improvement in network provisioning and asset management, helping organizations achieve superior operational efficiency and data integrity.

Accordingly, as discussed herein, the disclosed framework, via engine 200's comprehensive approach to network and asset provisioning management, delivers transformative improvements in operational efficiency, data accuracy and cost savings. By automating the entire process—from discovery and analysis to discrepancy resolution and monitoring—the disclosed framework can operate to streamline network data quality management, thereby reducing the manual intervention required and enabling operators to focus on higher-value tasks. The disclosed integration of the instant NDQ framework with multiple network management platforms, combined with its robust automation capabilities and predictive analytics, positions the instantly disclosed systems and methods as essential computerized tools for modern network management infrastructures, offering a powerful solution for organizations seeking to maintain high-quality network data and streamline operations.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying data related to network provisions;
identifying data related to asset provisions, the assets being identifiable from an inventory associated with at least one network;
analyzing, by an application, the network provisions data and the asset provisions data;
determining, by the application, based on the analysis, a discrepancy between the asset provisions and the network provisions;
determining, based on the discrepancy, a resolution related to at least one of the network provisions or the inventory; and
implementing the resolution.

2. The method of claim 1, further comprising the implementation comprising a device automatically executing the resolution to modify at least one of the network provisions or inventory.

3. The method of claim 1, further comprising:
compiling a dashboard, the dashboard configured as a displayable and interactive user interface (UI) that displays the network provision data, asset provisions data and real-time updates on a status related to resolution of the discrepancy via the implemented resolution.

4. The method of claim 3, further comprising the dashboard comprising a list of resolutions that are selectable for implementation, such that the implemented resolution is performed upon selection.

5. The method of claim 1, further comprising:
monitoring performance of the resolution;
determining whether the resolution was effective; and
performing rollback operations to a status prior to the implementation of the resolution when the determination indicates the resolution was ineffective.

6. The method of claim 1, further comprising storing information related to the resolution in a log file, the log file being accessible by an operator for performing an audit of the implemented resolution.

7. The method of claim 1, further comprising:
analyzing, by the application, the discrepancy; and
performing the determination of the resolution based on the application-based analysis of the discrepancy.

8. The method of claim 1, further comprising the application comprising an artificial intelligence algorithm or machine learning algorithm.

9. The method of claim 1, further comprising the network provisions corresponding to a single network.

10. The method of claim 1, further comprising the network provisions corresponding to a plurality of networks, such that the implementation of the resolution is performed for at least a portion of the networks.

11. A system comprising:
a processor configured to:
identify data related to network provisions;
identify data related to asset provisions, the assets being identifiable from an inventory associated with at least one network;
analyze, by an application, the network provisions data and the asset provisions data;
determine, by the application, based on the analysis, a discrepancy between the asset provisions and the network provisions;
determine, based on the discrepancy, a resolution related to at least one of the network provisions or the inventory; and
implement the resolution.

12. The system of claim 11, wherein the processor is further configured such that the implementation comprises the processor automatically executing the resolution to modify at least one of the network provisions or inventory.

13. The system of claim 11, wherein the processor is further configured to:
compile a dashboard, the dashboard configured as a displayable and interactive user interface (UI) that displays the network provision data, asset provisions data and real-time updates on a status related to resolution of the discrepancy via the implemented resolution.

14. The system of claim 13, wherein the processor is further configured such that the dashboard comprises a list of resolutions that are selectable for implementation, such that the implemented resolution is performed upon selection.

15. The system of claim 11, wherein the processor is further configured to:
monitor performance of the resolution;
determine whether the resolution was effective; and
perform rollback operations to a status prior to the implementation of the resolution when the determination indicates the resolution was ineffective.

16. A non-transitory computer-readable storage medium tangibly encoded with computer-executable instructions that when executed by a device, perform a method comprising:
identifying data related to network provisions;
identifying data related to asset provisions, the assets being identifiable from an inventory associated with at least one network;
analyzing, by an application, the network provisions data and the asset provisions data;
determining, by the application, based on the analysis, a discrepancy between the asset provisions and the network provisions;
determining, based on the discrepancy, a resolution related to at least one of the network provisions or the inventory; and
implementing the resolution.

17. The non-transitory computer-readable storage medium of claim 16, further comprising the implementation comprising a device automatically executing the resolution to modify at least one of the network provisions or inventory.

18. The non-transitory computer-readable storage medium of claim 16, further comprising:
compiling a dashboard, the dashboard configured as a displayable and interactive user interface (UI) that displays the network provision data, asset provisions data and real-time updates on a status related to resolution of the discrepancy via the implemented resolution.

19. The non-transitory computer-readable storage medium of claim 18, further comprising the dashboard comprising a list of resolutions that are selectable for implementation, such that the implemented resolution is performed upon selection.

20. The non-transitory computer-readable storage medium of claim 16, further comprising:
monitoring performance of the resolution;
determining whether the resolution was effective; and
performing rollback operations to a status prior to the implementation of the resolution when the determination indicates the resolution was ineffective.
